(19) United States
(12) Patent Application Publication
(10) Pub. No.: US 2022/0066746 A1
(43) Pub. Date: Mar. 3, 2022

(54) SYSTEMS AND METHODS FOR GRAPHICAL PROGRAMMING AND DEPLOYMENT OF DISTRIBUTED LEDGER APPLICATIONS

(71) Applicant: JPMORGAN CHASE BANK, N.A., New York, NY (US)

(72) Inventors: Ziv GAFNI, Savion (IL); Jacob MENDEL, Givat Brenner (IL); Shafir BALITSKY, Givaataim (IL)

(21) Appl. No.: 17/459,297

(22) Filed: Aug. 27, 2021

Related U.S. Application Data
(60) Provisional application No. 63/072,364, filed on Aug. 31, 2020.

(51) Int. Cl. G06F 8/34; G06F 8/60

(52) U.S. Cl. CPC G06F 8/34; G06F 8/60

(57) ABSTRACT

Systems and methods for Unified Modeling Language application development on distributed ledgers are disclosed. In one embodiment, a method for graphical programming and deployment of distributed ledger applications may include: (1) receiving, at a coding engine executed by a computer processor, a graphical program for a distributed ledger application comprising a process and a plurality of deployment parameters; (2) retrieving, by the coding engine and from a deployment data database, deployment data for the plurality of deployment parameters; (3) generating, by the coding engine, the distributed ledger application based on the graphical program and the deployment data; and (4) deploying, by the coding engine, the distributed ledger application to a deployment environment.

### RELATED APPLICATIONS

This application claims priority to, and the benefit of, U.S. Provisional Patent Application Ser. No. 63/072,364, filed Aug. 31, 2020, the disclosure of which is hereby incorporated, by reference, in its entirety.

### BACKGROUND OF THE INVENTION

### 1. Field of the Invention

Embodiments relate generally to systems and methods for graphical programming and deployment of distributed ledger applications.

### 2. Description of the Related Art

In general, to automate a process on a computer, an individual must have specific knowledge of coding principles. In addition, the processes need to have all of the necessary security and controls required for the specific types of data input.

### SUMMARY OF THE INVENTION

Systems and methods for graphical programming and deployment of distributed ledger applications are disclosed. In one embodiment, a method for graphical programming and deployment of distributed ledger applications may include: (1) receiving, at a coding engine executed by a computer processor, a graphical program for a distributed ledger application comprising a process and a plurality of deployment parameters; (2) retrieving, by the coding engine and from a deployment data database, deployment data for the plurality of deployment parameters; (3) generating, by the coding engine, the distributed ledger application based on the graphical program and the deployment data; and (4) deploying, by the coding engine, the distributed ledger application to a deployment environment.

In one embodiment, the graphical program may be programmed in a graphical programming language.

In one embodiment, one of the plurality of deployment parameters may include a distributed ledger technology, the deployment environment, a consensus mechanism, and/or a smart contract language for the distributed ledger application.

In one embodiment, the deployment environment may be associated with a cloud provider.

In one embodiment, one of the plurality of deployment parameters may include a deployment jurisdiction.

In one embodiment, the deployment data for the plurality of deployment parameters may include configuration files, services, and/or scripts.

In one embodiment, the method may further include configuring, by the coding engine, the deployment environment.

In one embodiment, the method may further include storing, by the coding engine, the deployment data for the plurality of deployment parameters in a stored deployment data database comprising a plurality of sets of stored deployment data.

In one embodiment, the method may further include receiving, by the coding engine, a second graphical program for a second distributed ledger application and a second plurality of deployment parameters; identifying, by the coding engine and using a trained machine learning algorithm, a set of stored deployment data for the second graphical program and the second plurality of deployment parameters; and generating, by the coding engine, the second distributed ledger application based on the second graphical program and the set of stored deployment data.

In one embodiment, the method may further include receiving, by the coding engine, a plurality of approvals for deployment of the distributed ledger application to the deployment environment; and storing, by the coding engine, the plurality of approvals.

According to another embodiment, a system may include: a user interface executed by a user electronic device that receives a graphical program for a distributed ledger application comprising a process and a plurality of deployment parameters; a deployment data database storing deployment data; a deployment environment; and a coding engine executed by a computer processor that is configured to receive the graphical program and the plurality of deployment parameters from the user interface, retrieve deployment data for the plurality of deployment parameters from the deployment data database, generate the distributed ledger application based on the graphical program and the deployment data, and deploy the distributed ledger application to the deployment environment.

In one embodiment, the graphical program may be programmed in a graphical programming language.

In one embodiment, one of the plurality of deployment parameters may include a distributed ledger technology, the deployment environment, a consensus mechanism, and/or a smart contract language for the distributed ledger application.

In one embodiment, the deployment environment may be associated with a cloud provider.

In one embodiment, one of the plurality of deployment parameters may include a deployment jurisdiction.

In one embodiment, the deployment data for the plurality of deployment parameters may include configuration files, services, and/or scripts.

In one embodiment, the coding engine may be further configured to configure the deployment environment.

In one embodiment, the coding engine may be further configured to store the deployment data for the plurality of deployment parameters in a stored deployment data database comprising a plurality of sets of stored deployment data.

In one embodiment, the coding engine may be further configured to receive a second graphical program for a second distributed ledger application and a second plurality of deployment parameters, identify a set of stored deployment data for the second graphical program and the second plurality of deployment parameters using a trained machine learning algorithm, and generate the second distributed ledger application based on the second graphical program and the set of stored deployment data.

In one embodiment, the coding engine may be further configured to receive a plurality of approvals for deployment of the distributed ledger application to the deployment environment, and store the plurality of approvals.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for graphical programming and deployment of distributed ledger applications according to an embodiment;

FIG. 2 depicts a method for graphical programming and deployment of distributed ledger applications according to an embodiment;

FIG. 3 depicts a first screenshot of a user interface in which a graphical programming language is used to program a process according to one embodiment;

FIG. 4 depicts a second screenshot of a user interface in which a graphical programming language is used to program a process according to one embodiment;

FIG. 5 depicts an exemplary user interface in which the user may select deployment parameters according to an embodiment.

### DETAILED DESCRIPTION OF PREFERRED EMBODIMENTS

Embodiments relate generally to systems and methods for graphical programming and deployment of distributed ledger applications.

Using a graphical programming language, such as the Unified Modeling Language (UML), users may “draw” a process diagram, specify deployment parameters, and then have a coding engine generate an application and deploy the application to a selected environment, such as a cloud provider, using a selected distributed ledger platform, such as a Blockchain-based platform (e.g., Ethereum, Quorum, Hyperledger Fabric, R3 Corda, etc.).

Embodiments may fully automate the deployment process, including the ability for entities to work together and to request and receive appropriate signoffs, etc. at each stage using smart contracts.

Embodiments apply the appropriate compliance, regulatory, and cyber controls to the process to ensure compliance with the data handling requirements in various jurisdictions throughout the world. Embodiments may adapt to changes in privacy laws in the various jurisdictions, and provide version controlling to ensure continuous compliance. For example, parameters specific to certain jurisdictions may be retrieved from one or more databases, input devices, etc. and may be incorporated into the program.

Embodiments may further leverage machine learning technology to predict deployment and other parameters based on past deployments.

Embodiments may reduce the cost/time associated with developing distributed ledger-based solutions by leveraging the benefits provided by distributed ledger technologies (e.g., transparency, security, immutability, etc.) without exposing their complexities to the end users. In embodiments, users will provide minimal to no coding to generate and deploy applications.

Embodiments may leverage smart contracts to model target processes and their parties' (i.e., actors') obligations. The smart contacts may separate the processes/workflows models (e.g., selected graphical programming language notations and models) describing the obligations of all parties, and the deployment expectations rationalizing the modeled process flows on the actual physical network (i.e., describe the “how”), and the end-user's views and experience during the process/workflow executions. In embodiments, smart contracts may be used to generate and/or deploy the program to the deployment environment.

Embodiments may provide at least some of the following benefits:

1. Simplified distributed ledger application development: Current use-cases development over distributed ledgers take time and customization per case. Instead, a simplified business logic solution shortens production times and ease the initial development phase;

2. Anyone can use the distributed ledger application: The current barriers for developing a distributed ledger application is only preserved to those who learned exotic smart contract languages. Instead of learning a language or allowing for engineers, a graphical programming language solution assists analysts and other functions to drag-and-drop a business case and deploy it in seconds to the cloud;

3. Modular solutions enabled: The use of the graphical programming language makes not only the development easy, but also makes the deployment easy—a distributed ledger solution that is production-ready with configurable properties. This may include the cloud provider on which to deploy to, the relevant consensus mechanism run (in terms of scalability needed per case), and the smart contract language and distributed ledger to which to translate the graphical programming language.

In embodiments, a process workflow (e.g., the who and what) may be received via the graphical programming language. The deployment approach that may specify the configuration and model execution engine, may be reflect security or performance requirements that do not impact the process, may be received from the user. The uses may leverage WYSIWYG UI tools to model the user's experience.

Although this description may be provided in the context of UML, it should be recognized that other programming languages, including other graphical programming languages, may be used as is necessary and/or desired.

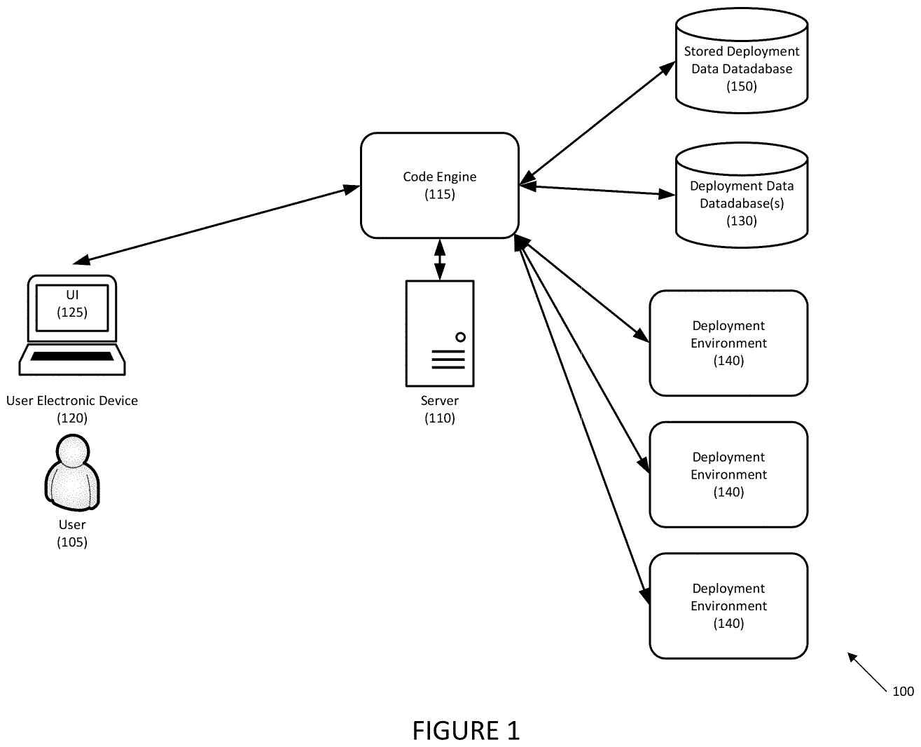

Referring to FIG. 1, an exemplary system for application development on distributed ledgers is disclosed according to one embodiment. System 100 may include, for example, server 110 (e.g., physical, cloud-based, combinations) that may execute coding engine 115 that may facilitate graphical programming of a distributed ledger-based application using, for example, UML. Coding engine 115 may interface with user interface (UI) 125 on user electronic device 120 (e.g., computer, smart device, etc.).

User 105 may graphically define a program for deployment and may identify deployment parameters, such as the distributed ledger technology (e.g., Ethereum, Quorum, Hyperledger Fabric, R3 Corda, etc.), consensus mechanism (e.g., Raft, Istanbul, Proof-of-Stake, Proof-of-Authority, etc.), cloud provider (e.g., AWS, Google Cloud, Microsoft Azure, Gaia, etc.), smart contract language (e.g., Solidty, Go, JAVA, Python, etc.), deployment nodes, deployment jurisdictions, etc. in user interface 125. Coding engine 115 may retrieve any necessary data, information, etc. for deployment from one or more deployment data database 130. Deployment data databases 130 may store, for example, configuration files, services, scripts, Personal identifiable information (PII) parameters/restrictions, jurisdictional requirements, etc. that may be specific to the deployment parameters.

Coding engine 115 may also generate and deploy an application for deployment to deployment environment 140, such as an environment provided by one or more cloud providers (e.g., AWS, Google Cloud, Microsoft Azure, Gaia, etc.). For example, coding engine 115 may receive the graphical program, deployment parameters, etc. and may generate and compile the program. Coding engine 115 may further deploy the program to the destination platform.

System 100 may further include stored deployment data database 150 that may store sets of retrieved deployment data.

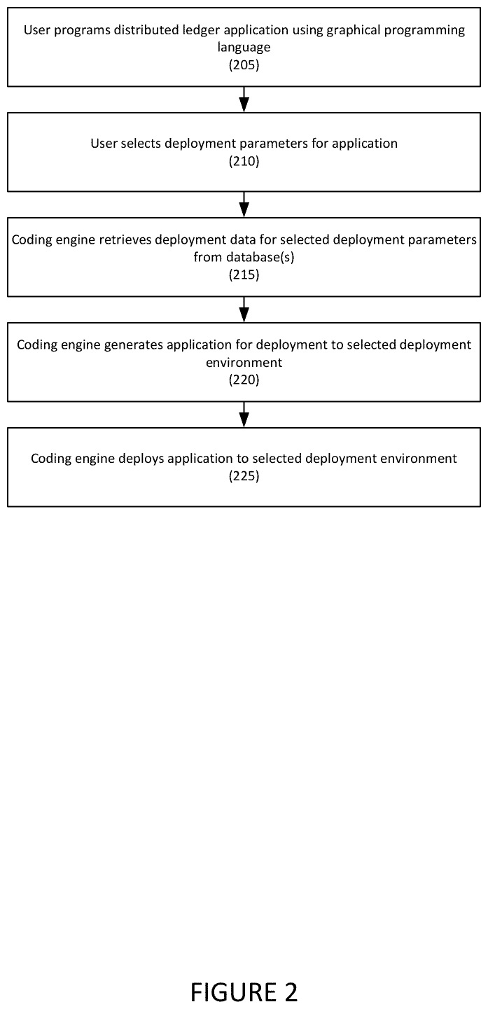

Referring to FIG. 2, a method for graphical programming and deployment of distributed ledger applications is provided according to an embodiment. In step 205, a user may graphically program a distributed ledger application using a graphical programming language, such as UML. In one embodiment, the user may graphically identify one or more process to be executed.

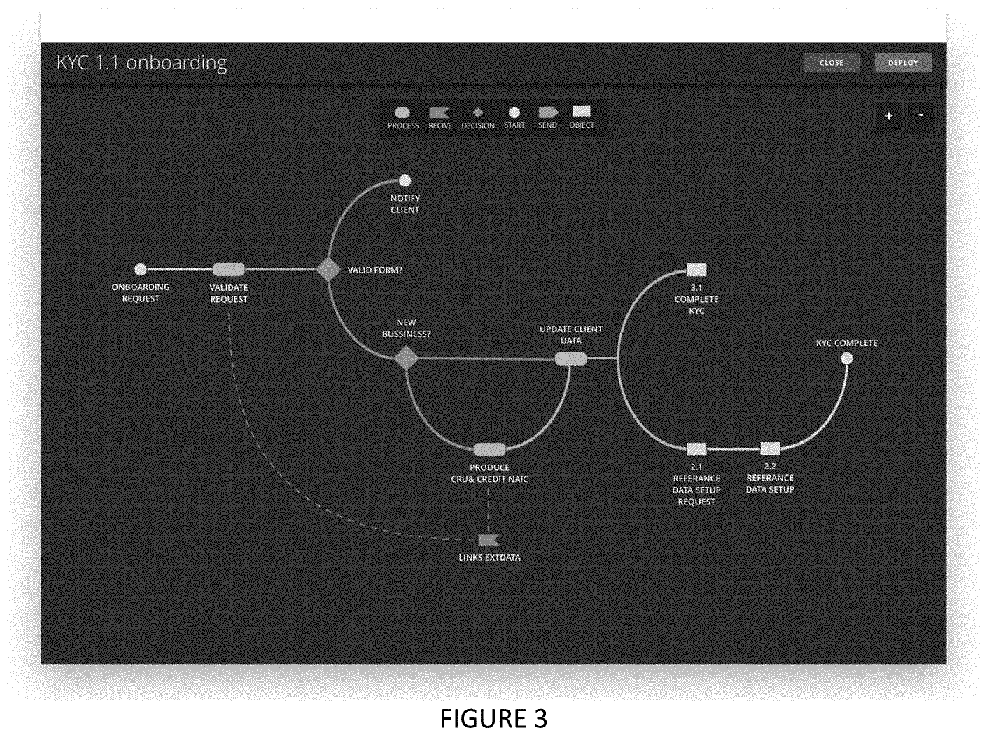

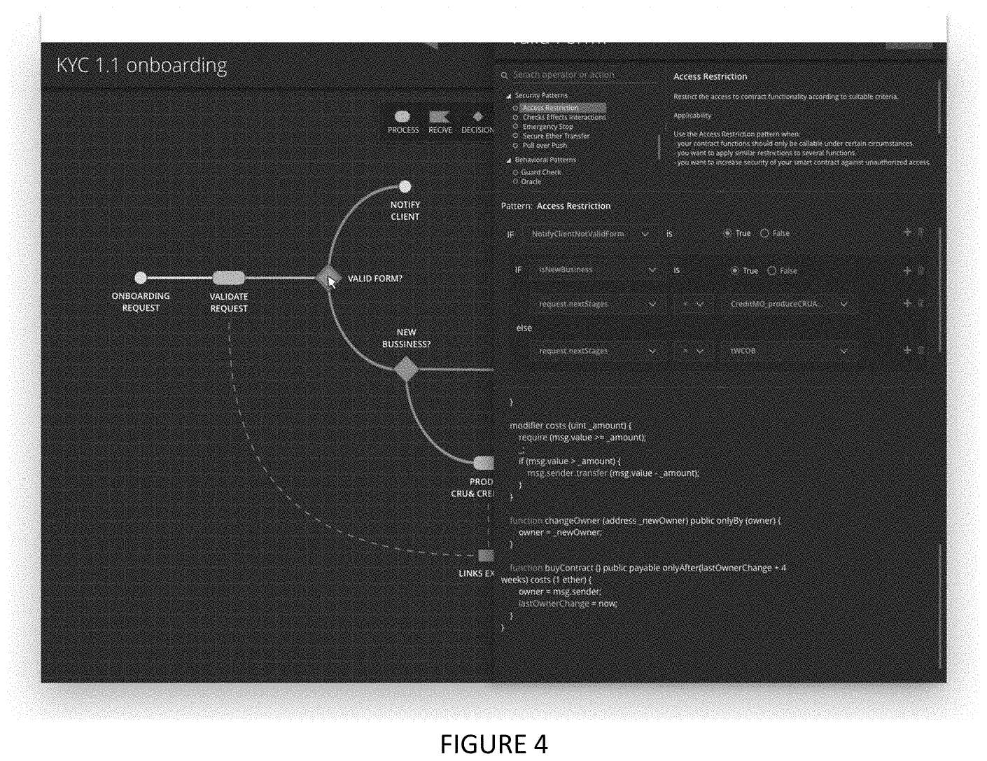

FIGS. 3 and 4 depict screenshots of user interfaces in which a graphical programming language (e.g., UML) is used to program a process, such as a know your customer (KYC) onboarding process, as a distributed ledger-based application, according to one embodiment. FIG. 3 depicts a program with including decisions, receipt of information, sending of information, start/stop, objects, etc. FIG. 4 depicts the definition of the decision for “Valid Form.” The user may specify security patterns, behavior patterns, etc. and may further provide if/then/else parameters for the decision process.

In one embodiment, code for each selection may be generated and displayed as the user makes the selections.

In step 210, the user may select deployment parameters, such as the distributed ledger technology to use (e.g., Ethereum, Quorum, Hyperledger Fabric, R3 Corda, etc.), the cloud provider (e.g., Amazon AWS, Google Cloud GCP, Microsoft Azure, Gaia, etc.), the consensus mechanism (e.g., Raft, Istanbul, Proof-of-Stake, Proof-of-Authority, etc.), the smart contract language (e.g., Solidity, Go, Java, Python, C++, etc.), and the nodes to deploy the code to (e.g., Organization A, Organization B, etc.). In one embodiment, the user may select one or more jurisdiction in which the application will be deployed.

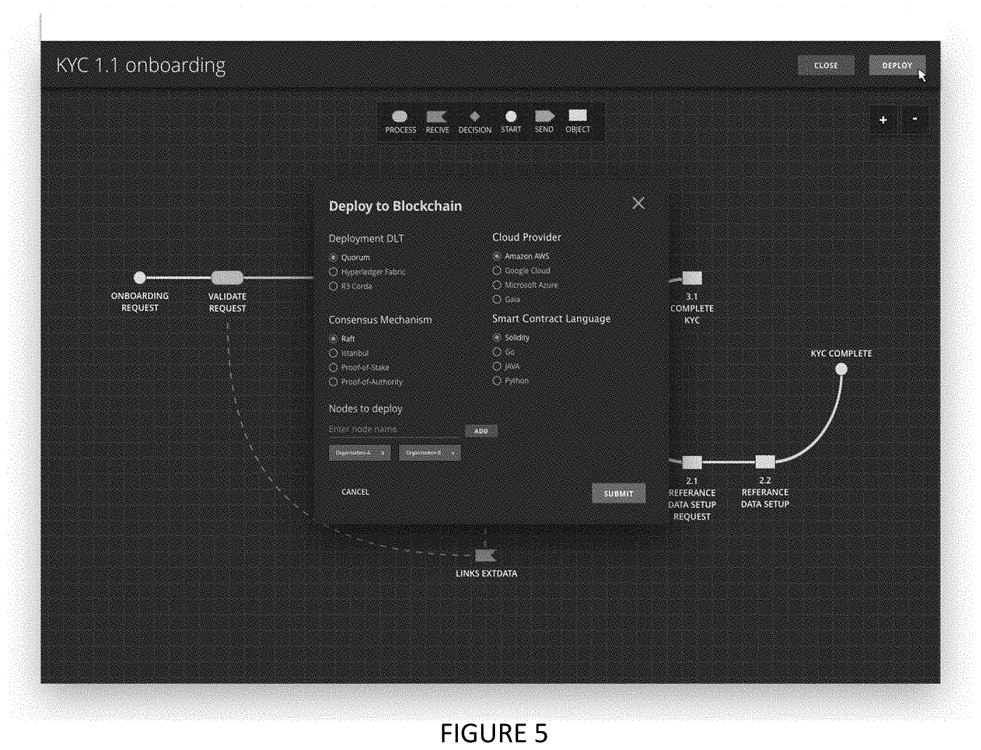

FIG. 5 depicts an exemplary user interface in which the user may select deployment parameters according to an embodiment. For example, when the user selects “Deploy,” an interface may be presented that allows the user to select the distributed ledger technology (e.g., Ethereum, Quorum, Hyperledger Fabric, R3 Corda, etc.), the cloud provider (e.g., Amazon AWS, Google Cloud GCP, Microsoft Azure, Gaia, etc.), the consensus mechanism (e.g., Raft, Istanbul, Proof-of-Stake, Proof-of-Authority, etc.), the smart contract language (e.g., Solidity, Go, Java, Python, C++, etc.), and the nodes to deploy the code to (e.g., Organization A, Organization B, etc.).

In step 215, once the deployment parameters are received, the coding engine may retrieve data, such as configuration files, services, scripts, etc. for the selected deployment parameters from one or more deployment data database. For example, the coding engine may retrieve data specific to the deployment platform, the consensus mechanism, the deployment jurisdiction, etc. from one or more databases.

In embodiments, the code may be generated using machine learning that transforms the graphical program into the appropriate computer language for the selected parameters. Machine learning may also be used to select the appropriate API for the selected distributed ledger technology. The code may then be deployed to the nodes.

In one embodiment, the coding engine may retrieve the latest data handling (e.g. PII) restrictions for the jurisdictions in which the application is deployed. In one embodiment, the coding engine may require entitlement checks before users are granted access, may ensure that data is encrypted at rest, in transit, etc. as required. The coding engine may use the existing infrastructure, cryptographic libraries, etc. to implement these restrictions.

In step 220, the coding engine may generate an application for deployment to a selected deployment environment, and, in step 225, may deploy the application to the selected deployment environment, such as a cloud provider. The coding engine may further establish connections with the identified nodes for the distributed ledger participants based on the deployment parameters.

In one embodiment, as part of deployment, the coding engine or a separate program may receive approvals for deployment. For example, a multi-signature approach may be used. Each party that is required to sign-off for deployment may be required to digitally sign a deployment approval before the application is deployed. The approval may be received in a certain order (e.g., a hierarchy), separately from each party, etc.

In one embodiment, the deployment parameters may be saved in a database and may be used to train a machine learning engine for future application deployments. For example, the trained machine learning engine may predict deployment parameters based on similarities between the program, the user, etc. and may pre-populate deployment parameters based on its predictions.

In one embodiment, the identified configuration files, services, scripts, etc., may be stored for future retrieval so that a subsequent application with the same deployment parameters may be generated without retrieving all of the configuration files, services, scripts, etc., from the database.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for graphical programming and deployment of distributed ledger applications, comprising:
receiving, at a coding engine executed by a computer processor, a graphical program for a distributed ledger application comprising a process and a plurality of deployment parameters;
retrieving, by the coding engine and from a deployment data database, deployment data for the plurality of deployment parameters;
generating, by the coding engine, the distributed ledger application based on the graphical program and the deployment data; and
deploying, by the coding engine, the distributed ledger application to a deployment environment.

2. The method of claim 1, wherein the graphical program is programmed in a graphical programming language.

3. The method of claim 1, wherein one of the plurality of deployment parameters comprises a distributed ledger technology, the deployment environment, a consensus mechanism, and/or a smart contract language for the distributed ledger application.

4. The method of claim 1, wherein the deployment environment is associated with a cloud provider.

5. The method of claim 1, wherein one of the plurality of deployment parameters comprises a deployment jurisdiction.

6. The method of claim 1, wherein the deployment data for the plurality of deployment parameters comprises configuration files, services, and/or scripts.

7. The method of claim 1, further comprising:
configuring, by the coding engine, the deployment environment.

8. The method of claim 1, further comprising:
storing, by the coding engine, the deployment data for the plurality of deployment parameters in a stored deployment data database comprising a plurality of sets of stored deployment data.

9. The method of claim 8, further comprising:
receiving, by the coding engine, a second graphical program for a second distributed ledger application and a second plurality of deployment parameters;
identifying, by the coding engine and using a trained machine learning algorithm, a set of stored deployment data for the second graphical program and the second plurality of deployment parameters; and
generating, by the coding engine, the second distributed ledger application based on the second graphical program and the set of stored deployment data.

10. The method of claim 1, further comprising:
receiving, by the coding engine, a plurality of approvals for deployment of the distributed ledger application to the deployment environment; and
storing, by the coding engine, the plurality of approvals.

11. A system comprising:
a user interface executed by a user electronic device that receives a graphical program for a distributed ledger application comprising a process and a plurality of deployment parameters;
a deployment data database storing deployment data;
a deployment environment; and
a coding engine executed by a computer processor that is configured to receive the graphical program and the plurality of deployment parameters from the user interface, retrieve deployment data for the plurality of deployment parameters from the deployment data database, generate the distributed ledger application based on the graphical program and the deployment data, and deploy the distributed ledger application to the deployment environment.

12. The system of claim 11, wherein the graphical program is programmed in a graphical programming language.

13. The system of claim 11, wherein one of the plurality of deployment parameters comprises a distributed ledger technology, the deployment environment, a consensus mechanism, and/or a smart contract language for the distributed ledger application.

14. The system of claim 11, wherein the deployment environment is associated with a cloud provider.

15. The system of claim 11, wherein one of the plurality of deployment parameters comprises a deployment jurisdiction.

16. The system of claim 11, wherein the deployment data for the plurality of deployment parameters comprises configuration files, services, and/or scripts.

17. The system of claim 11, wherein the coding engine is further configured to configure the deployment environment.

18. The system of claim 11, wherein the coding engine is further configured to store the deployment data for the plurality of deployment parameters in a stored deployment data database comprising a plurality of sets of stored deployment data.

19. The system of claim 18, wherein the coding engine is further configured to receive a second graphical program for a second distributed ledger application and a second plurality of deployment parameters, identify a set of stored deployment data for the second graphical program and the second plurality of deployment parameters using a trained machine learning algorithm, and generate the second distributed ledger application based on the second graphical program and the set of stored deployment data.

20. The system of claim 11, wherein the coding engine is further configured to receive a plurality of approvals for deployment of the distributed ledger application to the deployment environment, and store the plurality of approvals.
